(19) United States
(12) Patent Application Publication
(10) Pub. No.: US 2024/0200498 A1
(43) Pub. Date: Jun. 20, 2024

(54) Igniter Port Retention System

(71) Applicant: Rolls-Royce North American Technologies Inc., Indianapolis, IN (US)

(72) Inventor: Kevin Sauer, Indianapolis, IN (US)

(73) Assignee: Rolls-Royce North American Technologies Inc., Indianapolis, IN (US)

(21) Appl. No.: 18/067,367

(22) Filed: Dec. 16, 2022

(51) Int. Cl. F02C 7/264

(52) U.S. Cl. CPC F02C 7/264; F05D 2230/64; F05D 2240/35; F05D 2260/36; F05D 2260/99

(57) ABSTRACT

A combustor igniter port assembly is disclosed. The assembly may be installed in a combustor section of a gas turbine engine. The combustor igniter port assembly may include a combustor tower positionable to project radially outward from a combustor outer wall forming a radially outer surface of the combustor section. The combustor tower may be positionable on the combustor outer wall to encircle an aperture included in the combustor wall. The combustor tower may include a keeper on an inner wall of the combustor tower. The assembly may include a ferrule disposed radially outward from at least a portion of the combustor tower. The assembly may include a retention ring disposed within the keeper of the combustor tower. The retention ring may have elasticity to vary the diameter of the retention ring.

### TECHNICAL FIELD

This disclosure relates to combustor assemblies and, in particular, to turbine engine combustor igniter port retention.

### BACKGROUND

Present combustor igniter port assemblies from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a cross-sectional view of an example of a gas turbine engine;

FIG. 2 illustrates a cross-sectional view of an example of a combustor igniter port assembly;

FIG. 3 illustrates a cross-sectional view of an example of a combustor igniter port assembly;

FIG. 4 illustrates an example of a retention ring; and

FIG. 5 illustrate an example method of assembling a combustor igniter port assembly.

### DETAILED DESCRIPTION

A combustor igniter port assembly is disclosed. The assembly may be installed in a combustor section of a gas turbine engine. The combustor igniter port assembly may include a combustor tower positionable to project radially outward from a combustor outer wall forming a radially outer surface of the combustor section. The combustor tower may be positionable on the combustor outer wall to encircle an aperture included in the combustor wall. The combustor tower may include a keeper on an inner wall of the combustor tower. The assembly may include a ferrule disposed radially outward from at least a portion of the combustor tower. The ferrule may include a flange. The assembly may include a retention ring disposed within the keeper of the combustor tower, wherein the flange of the ferrule disposed radially outward of at least a portion of the combustor tower and radially inward of the retention ring. The retention ring may have elasticity to vary the diameter of the retention ring.

One interesting feature of the systems and methods described below may be that the retention ring design make the assembly, for example, the ferrule, combustor tower igniter, and/or combustor section easier to inspect. For example, because the retention ring can be easily compressed and/or released, installation and/or inspection is easier, for example, during original OEM manufacture of the combustor section. The retention ring design requires no welding unlike conventional retention ring designs, which makes assembly and inspection quicker and less expensive. Additionally or alternatively, the retention ring enables easier and quicker removal of the retention ring when, for example, inspecting the area for wear and/or needed replacement when compared to a traditional welded retention ring that requires cutting and/or grinding off the retention ring before it can be removed.

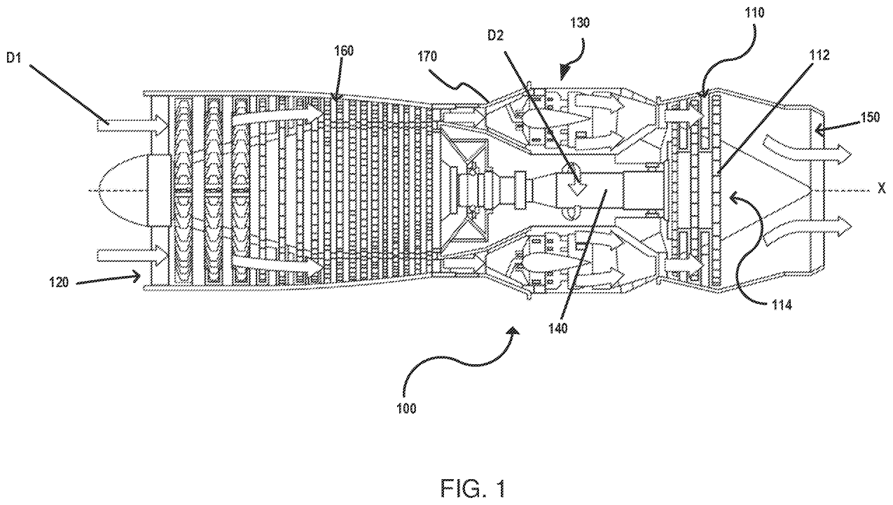

FIG. 1 is a cross-sectional view of a gas turbine engine 100. In some examples, the gas turbine engine 100 may supply power to and/or provide propulsion of an aircraft. Examples of the aircraft may include a helicopter, an airplane, an unmanned space vehicle, a fixed wing vehicle, a variable wing vehicle, a rotary wing vehicle, an unmanned combat aerial vehicle, a tailless aircraft, a hover craft, and any other airborne and/or extraterrestrial (spacecraft) vehicle. Alternatively or in addition, the gas turbine engine 100 may be utilized in a configuration unrelated to an aircraft such as, for example, an industrial application, an energy application, a power plant, a pumping set, a marine application (for example, for naval propulsion), a weapon system, a security system, a perimeter defense or security system.

The gas turbine engine 100 may take a variety of forms in various embodiments. Though depicted as an axial flow engine, in some forms the gas turbine engine 100 may have multiple spools and/or may be a centrifugal or mixed centrifugal/axial flow engine. In some forms, the gas turbine engine 100 may be a turboprop, a turbofan, or a turboshaft engine. Furthermore, the gas turbine engine 100 may be an adaptive cycle and/or variable cycle engine. Other variations are also contemplated.

The gas turbine engine 100 may include an intake section 120, a compressor section 160, a combustor section 130, a turbine section 110, and an exhaust section 150. During operation of the gas turbine engine 100, fluid received from the intake section 120, such as air, travels along the direction D1 and may be compressed within the compressor section 160. The compressed fluid may then be mixed with fuel and the mixture may be burned in the combustor section 130. The combustor section 130 may include any suitable fuel injection and combustion mechanisms. The hot, high pressure fluid may then pass through the turbine section 110 to extract energy from the fluid and cause a turbine shaft of a turbine 114 in the turbine section 110 to rotate, which in turn drives the compressor section 160. Discharge fluid may exit the exhaust section 150.

As noted above, the hot, high pressure fluid passes through the turbine section 110 during operation of the gas turbine engine 100. As the fluid flows through the turbine section 110, the fluid passes between adjacent blades 112 of the turbine 114 causing the turbine 114 to rotate. The rotating turbine 114 may turn a shaft 140 in a rotational direction D2, for example. The blades 112 may rotate around an axis of rotation, which may correspond to a centerline X of the turbine 114 in some examples.

The gas turbine engine 100 may include an engine case 170. The engine case may extend along all or at least along part of the gas turbine engine 100, forming an outer wall of the gas turbine engine 100. Additionally or alternatively, the case 170 may form an outer wall of the turbine section 110, the intake section 120, the combustor section 130, the exhaust section 150, and/or the compressor section 160. The combustor section 130 may be formed and extend about the centerline axis X of the turbine engine 100.

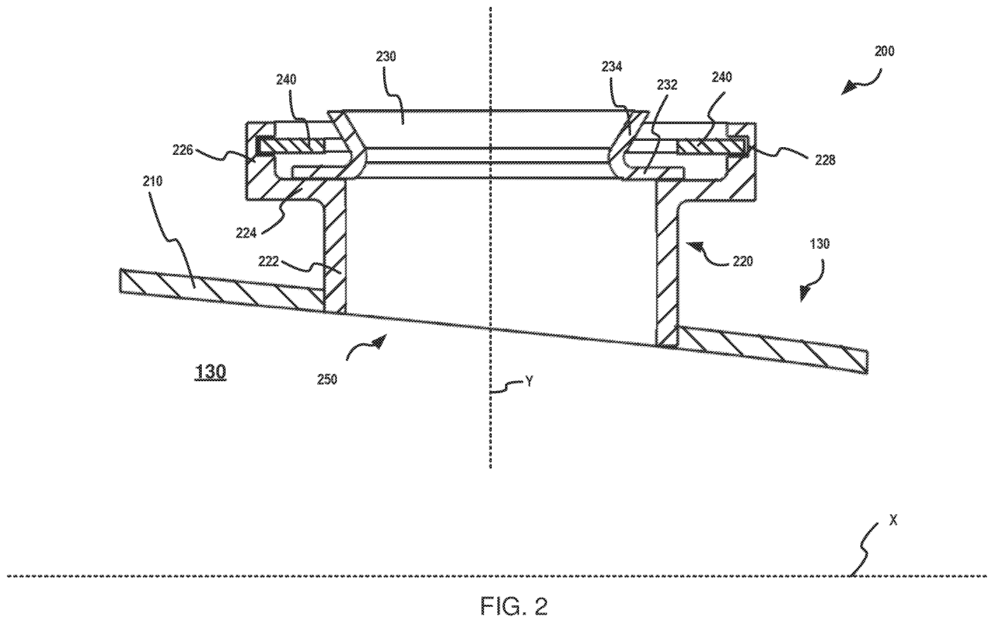

FIG. 2 shows a close up, cross-sectional view of a combustor igniter port assembly 200. The combustor igniter port assembly 200 may, for example, include a combustor tower 220, a ferrule 230, and a retention ring 240. The combustor igniter port assembly 200, may be disposed on an outer wall 210 of the combustor section 130. The outer wall 210 may, for example, be disposed around the centerline axis X of the turbine engine 100. The combustor tower 220 may have a centerline axis Y extending through the center of the combustor tower 220, parallel to the walls of the combustor tower 220.

The combustor tower 220 may protrude radially outward from the outer wall 210 of the combustor section 130. The combustor tower 220 may be, for example, cylindrically shaped. The combustor tower 220 may be, for example, circular in cross section, but may alternatively be another shape such as ovular, square, or irregularly shaped. The combustor tower 220 may be aligned with and disposed around an aperture 250 in the outer wall 210. The diameter of the combustor tower 220 and/or the aperture may be, for example, between 0.8-1.2 inches. The combustor tower 220 may, for example, extend outward substantially perpendicular, for example, within 10 degrees, to the outer surface of the outer wall 210. Additionally or alternatively, the combustor tower 220 may extend outward at a predetermined oblique angle with respect to the outer wall 210. The combustor tower 220 may include, for example, a high temperature nickel alloy, other alloy material, and/or any material capable of withstanding the high temperatures of the combustor section 130.

The combustor tower 220 may include a vertical wall 222, a horizontal flange 224, and vertical flange 226. The horizontal flange 224 may extend outward from the vertical wall 222 perpendicular to the axis Y, and be, for example, substantially perpendicular to the vertical wall 222. The vertical flange 226 may extend outward and/or upward from the horizontal flange 224, parallel to the axis Y. The vertical flange 226 may be, for example, substantially parallel to the vertical wall 222. The vertical flange 226 may be cylindrical in shape, and may have a diameter greater than the diameter of the vertical wall 222. The vertical flange 226 may include a keeper 228, for example, disposed perpendicular to the vertical flange 226. The keeper 228 may be disposed closer towards the radially outward end of the combustor tower 220 and the vertical flange 226 with respect to the axis X. The keeper 228 may not be disposed at the very end of the vertical flange 226 such that portion of the vertical flange 226 extends on either side of the keeper 228. The keeper 228 may be, for example, a recessed groove cutting into and extending along the vertical flange 226. Additionally, or alternatively, the keeper 228 may, for example, be one of more flanges extending out perpendicular from the vertical flange 226. The keeper 228 may extend continuously around the inner wall of the vertical flange 226, or, alternatively, the keeper 228 may be non-continuous and comprise multiple separate sections. The keeper 228 may be any component, shape, or feature that is able to keep the retention ring 240 in place on the vertical flange 226. The keeper may have, for example, dimensions of 0.80-1.2 inches.

The ferrule 230 may be, for example, disposed radially outward with respect to the central axis X from the vertical wall 222 and horizontal flange 224 of the combustor tower 220. For example, at least a portion of the ferrule 230 may be disposed within the diameter of the vertical flange 226. However, the ferrule 230 may not be attached, connected, and/or joined to the combustor tower 220. The ferrule 230 may be circular and/or cylindrical like the combustor tower 220 and/or retention ring 240 may be. Alternatively, the ferrule 230, combustor tower 220, and/or retention ring 240 may be irregularly shaped, or non-circular. The ferrule 230 may include a flange portion 232. The ferrule 230 may include a conical portion 234. The flange portion 232 of the ferrule 230 may have an inner and outer diameter. The outer diameter of the flange portion 232 may have a dimension larger than a diameter of the vertical wall 222 but smaller than a diameter of the vertical flange 226. The inner diameter of the flange portion 232 may be smaller in dimension than the diameter of the vertical wall 222. The conical portion 234 may extend radially outward, with respect to the centerline axis X, from the flange portion 232 at a predetermined oblique angle. Additionally or alternatively, the diameter of the conical portion 234 may increase as it extends radially outwards. The ferrule 230 may include any material that is compatible with the combustor tower 220, for example a cobalt alloy or other alloy material. The ferrule 230 may include a wear coating.

The retention ring 240 may be any sort of device that keep the ferrule 230 in place and can be compressed and expands into place, for example, via a spring or elasticity of ring material having shape memory and super elasticity. The retention ring 240 may be, for example, a snap ring, a spring loaded retention ring, a shape memory material ring, a ring with elasticity, a spiral lock ring, and/or any other device suitable for retaining. The retention ring 240 may, for example, be circular in shape, for example, a full or overlapping circular ring. In other examples, the ring 240 may be an elliptical shape, a pentagon shape, or a horse-shoe shape with non-continuous perimeter defining a gap.

The retention ring 240 may be disposed within the keeper 228 of the vertical flange 226. For example, the retention ring 240 may be compressed to a diameter smaller than an inner diameter of the vertical flange 226 and, from radially outward of the combustor tower 220, inserting the retention ring 240 radially inward into the combustor tower 220 towards the horizontal flange 224 and the central axis X. Once the retention ring 240 is inserted far enough into the combustor tower 220 where the retention ring 240 has reached the location of the keeper 228, the retention ring 240 may be released and permitted to expand and fill the keeper 228. For example, the retention ring 240 may expand such that an outer diameter of the retention ring 240 is substantially equal to, for example, within 10 millimeters, or smaller than a diameter of the keeper 228.

An inner diameter of the retention ring 240 may, for example, extend from the keeper 228 into the middle and/or center of the combustor tower 220 toward the central axis of the tower, for example, extending substantially parallel to the horizontal flange 224. The inner diameter of the retention ring 240, disposed closer towards the middle/central axis of the combustor tower 220, may be smaller in diameter than the outer diameter of the flange portion 232 of the ferrule 230. Accordingly, when the retention ring 240 is installed in the keeper 228, the flange portion 232 of the ferrule 230 may be disposed between and/or trapped between the horizontal flange 224 of the combustor tower 220 and the retention ring 240 such that the ferrule 230 cannot be removed from the combustor tower 220 when the retention ring 240 is installed in the combustor tower 220 keeper 228.

A cavity may be formed by the retention ring 240, the vertical flange 226, and the horizontal flange 224. The flange portion 232 of the ferrule 230 may be disposed within this cavity. This assembly 200 and/or retention ring arrangement may allow for the ferrule 230 to “float” and/or move radially outwards or radially inwards, with respect to the centerline axis X, between the retention ring 240 and the horizontal flange 224. Additionally or alternatively, the ferrule 240 may move or float in other directions, for example, parallel to the central axis X. The ferrule 230 may move, for example, due to pressure differences between the inside and outside of the combustor section 130, for example, radially inward of the outer wall 210 and radially outward of the outer wall 210. The floating ferrule 230 may allow for low leakage and differences in thermal growth between the igniter and the combustor section 130.

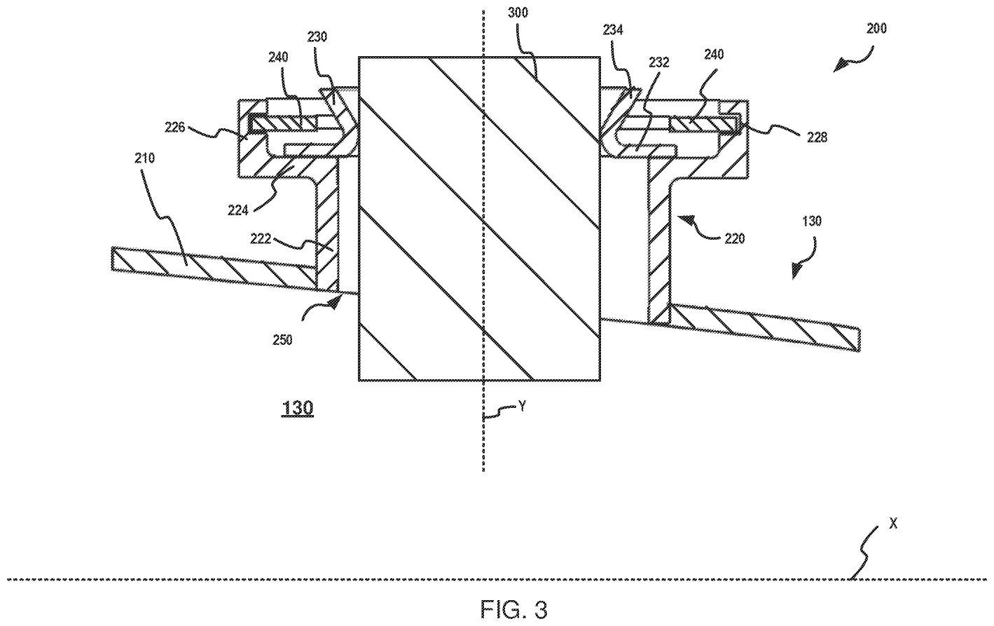

FIG. 3 illustrates a cross sectional view of the combustor igniter port assembly 200 with an igniter 300 inserted into the assembly 200 and the combustor section 130. The igniter 300 may be mounted to the engine case 170 (shown in FIG. 1), and extend from the engine case 170, through the combustor igniter port assembly 200, by extending through the ferrule 230, and into the combustor section 130. The igniter 300 may be used, for example, to ignite the fuel and/or gas mixture injected into the combustor section 130. The igniter 300 may be mounted, for example, on the engine case 170 (shown in FIG. 1), for example, mounted on to the interior and/or exterior wall of the engine case 170. The combustor section 130 may include the aperture 250 that acts as an igniter port. The igniter 300 may, for example, extend from the engine case 170, through the igniter port 250, and into the combustor section 130.

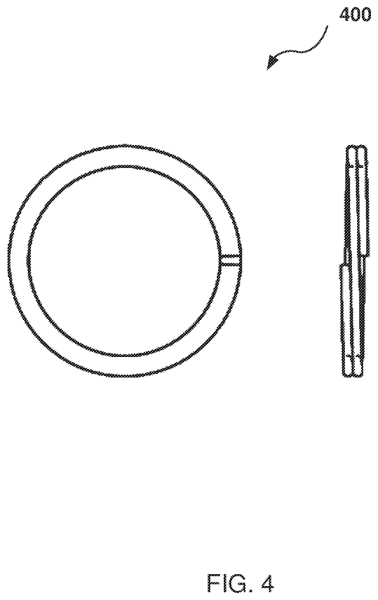

FIG. 4. Illustrates one example of a possible retention ring 240.

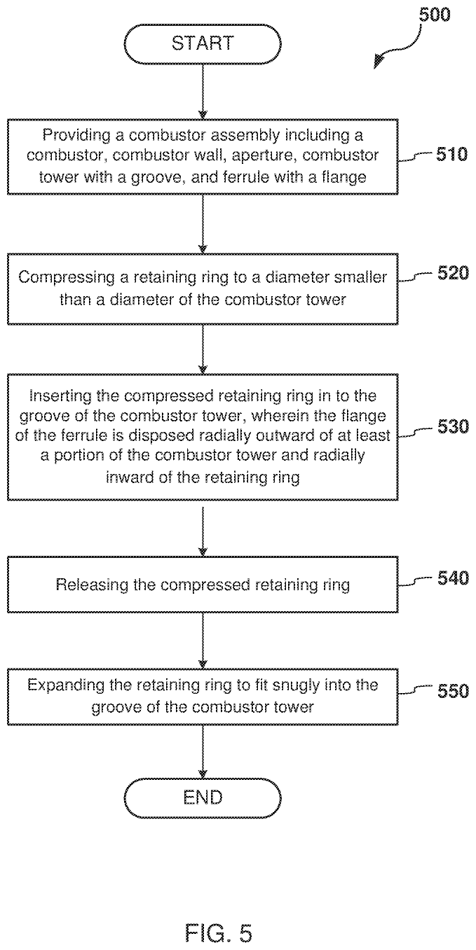

FIG. 5 illustrates a flow diagram of an example of steps for a process 500 to place and/or install a retention ring 240 in to a combustor igniter port assembly 200. The steps may include additional, different, or fewer operations than illustrated in FIG. 5. Additionally or alternatively, the steps may be executed in a different order than illustrated in FIG. 5, for example, the steps may be performed in reverse to remove or uninstall the retention ring 240 from the combustor igniter port assembly 200. The combustor section 130 assembly may be provided 510. The combustor section 130 assembly may include the combustor section 130 disposed about the centerline axis X of the gas turbine engine, a combustor outer wall 210 forming a radially outer surface of the combustor section 130, an aperture 250 formed by the combustor outer wall 210, and a combustor tower 220. The combustor tower 220 may project radially outward from the combustor outer wall 210. The combustor tower 220 may encircle the aperture 250. The combustor tower 220 may include a keeper 228 on an inner wall of the combustor tower 220. The combustor section 130 assembly may further include the ferrule 230. The ferrule 230 may be disposed radially outward from a portion of the combustor tower 220, for example, radially outward from the vertical wall 222. The ferrule 230 may include a flange portion 232.

The process 500 may further include compressing 530 the retention ring 240 to a diameter smaller than a diameter of an inner wall of the combustor tower 220. The compressed retention ring 240 may be inserted in to the keeper 228 of the combustor tower 220. When inserted, the flange portion 232 of the ferrule 230 may be disposed radially outward of at least a portion of the combustor tower 220 and radially inward of the retention ring 240. The compressed retention ring 240 may be released, and expanded to fit into the keeper 228 of the combustor tower 220.

Each component may include additional, different, or fewer components. For example, the combustor igniter port assembly 200 may include additional components other than the ferrule 230, retention ring 240, and combustor tower 220. For example, the combustor tower 220 may include more, fewer, or additional sections and/or parts, which may make up a unitary piece and/or make up separate, detachable sections.

Additionally or alternatively, the combustor section 130 may include multiple combustor igniter port assemblies 200. For example, multiple combustor igniter port assemblies 200 may be disposed circumferentially on the combustor section 130 about the centerline axis X.

The logic illustrated in the flow diagrams may include additional, different, or fewer operations than illustrated. The operations illustrated may be performed in an order different than illustrated.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:
A first aspect relates to a combustor igniter port assembly for a combustor section of a gas turbine engine, the combustor igniter port assembly comprising: a combustor tower positionable to project radially outward from a combustor outer wall forming a radially outer surface of the combustor section, the combustor tower positionable on the combustor outer wall to encircle an aperture included in the combustor wall, the combustor tower including a keeper on an inner wall of the combustor tower; a ferrule disposed radially outward from at least a portion of the combustor tower, the ferrule including a flange; and a retention ring disposed within the keeper of the combustor tower, the flange of the ferrule disposed radially outward of at least a portion of the combustor tower and radially inward of the retention ring, wherein the retention ring has elasticity to vary a diameter of the retention ring.
A second aspect relates to the combustor igniter port assembly of aspect 1, wherein the ferrule is sized to receive an igniter disposed at least partially in the combustor igniter port assembly.
A third aspect relates to the combustor igniter port assembly of any preceding aspect, wherein the igniter extends longitudinally through the ferrule.
A fourth aspect relates to the combustor igniter port assembly of any preceding aspect, wherein the combustor tower includes a vertical wall, a horizontal flange radially outward from the vertical wall, and a vertical flange radially outward from the horizontal flange.
A fifth aspect relates to the combustor igniter port assembly of any preceding aspect, wherein the keeper is a recessed groove.
A sixth aspect relates to the combustor igniter port assembly of any preceding aspect, wherein a cavity is formed by the retention ring, the vertical flange, and the horizontal flange.
A seventh aspect relates to the combustor igniter port assembly of any preceding aspect, wherein a portion of the ferrule is disposed within the cavity.
An eighth aspect relates to a method of installing a combustor igniter port retention ring, the method including: installing a combustor igniter port assembly, the combustor igniter port assembly including a combustor tower positionable to projecting radially outward from a combustor outer wall, the combustor tower positionable on the combustor outer wall to encircle an aperture included in the combustor wall, the combustor tower including a keeper on an inner wall of the combustor tower, and a ferrule disposed radially outward from at least a portion of the combustor tower, the ferrule including a flange, compressing a retention ring to a diameter smaller than a diameter of an inner wall of the combustor tower; inserting the compressed retention ring in to the keeper of the combustor tower where the flange of the ferrule is disposed radially outward of at least a portion of the combustor tower and radially inward of the retention ring; releasing the compressed retention ring; and expanding the retention ring to fit into the keeper of the combustor tower.
A ninth aspect relates to the method of aspect 8, wherein the keeper is a recessed groove in a wall of the combustor tower.
A tenth aspect relates to the method of any preceding aspect, wherein the combustor tower includes a vertical wall, a horizontal flange radially outward from the vertical wall, and a vertical flange radially outward from the horizontal flange.
An eleventh aspect relates to the method of any preceding aspect further comprising compressing the retention ring and removing the retention ring from the combustor tower.
A twelfth aspect relates to the method of any preceding aspect, wherein the retention ring is a snap ring.
A thirteenth aspect relates to the method of any preceding aspect, wherein the retention ring is a spiral lock type ring.
A fourteenth aspect relates to the method of any preceding aspect, wherein the retention ring is horseshoe shaped.
A fifteenth aspect relates to a combustor igniter port assembly comprising: a combustor tower projecting radially outward from a combustor outer wall of a combustor section of a gas turbine engine, the combustor outer wall forming a radially outer surface of the combustor section and the combustor tower positioned on the combustor outer wall to encircle an aperture included in the combustor wall, the combustor tower including a keeper on an inner wall of the combustor tower; a ferrule disposed radially outward from at least a portion of the combustor tower, the ferrule including a flange; and a retention ring disposed within the keeper of the combustor tower, the flange of the ferrule disposed radially outward of at least a portion of the combustor tower and radially inward of the retention ring, wherein the retention ring has elasticity to vary a diameter of the retention ring.
A sixteenth aspect relates to the combustor igniter port assembly of any preceding aspect, wherein the ferrule comprises a wear coating.
A seventeenth aspect relates to the combustor igniter port assembly of any preceding aspect, wherein a pressure outside of the combustor section radially outward of the combustor outer wall is greater than a pressure inside of the combustor section radially inward of the combustor outer wall.
An eighteenth aspect relates to the combustor igniter port assembly of any preceding aspect, wherein the combustor section is disposed within a gas turbine engine.
A nineteenth aspect relates to the combustor igniter port assembly of any preceding aspect, wherein the retention ring is a snap ring.
A twentieth aspect relates to the combustor igniter port assembly of any preceding aspect, wherein the retention ring is a spiral lock ring.

In addition to the features mentioned in each of the independent aspects enumerated above, some examples may show, alone or in combination, the optional features mentioned in the dependent aspects and/or as disclosed in the description above and shown in the figures.

1. A combustor igniter port assembly for a combustor section of a gas turbine engine, the combustor igniter port assembly comprising:
a combustor tower positionable to project radially outward from a combustor outer wall forming a radially outer surface of the combustor section, the combustor tower positionable on the combustor outer wall to encircle an aperture included in the combustor wall, the combustor tower including a keeper on an inner wall of the combustor tower and a horizontal flange, the horizontal flange axially spaced from the keeper;
a ferrule disposed radially outward from at least a portion of the combustor tower, the ferrule including a flange; and
a retention ring disposed within the keeper of the combustor tower, the flange of the ferrule disposed radially outward of at least a portion of the combustor tower and radially inward of the retention ring, the flange of the ferrule disposed between the horizontal flange and the retention ring, a gap disposed between the retention ring and the flange of the ferrule to allow axial movement of the ferrule,
wherein the retention ring has elasticity to vary a diameter of the retention ring.

2. The assembly of claim 1, wherein the ferrule is sized to receive an igniter disposed at least partially in the combustor igniter port assembly.

3. The assembly of claim 2, wherein the igniter extends longitudinally through the ferrule.

4. The assembly of claim 1, wherein the combustor tower includes a vertical wall, the horizontal flange radially outward from the vertical wall, and a vertical flange radially outward from the horizontal flange.

5. The assembly of claim 2, wherein the keeper is a recessed groove.

6. The assembly of claim 4, wherein a cavity is formed by the retention ring, the vertical flange, and the horizontal flange.

7. The assembly of claim 6, wherein a portion of the ferrule is disposed within the cavity.

8. A method of installing a combustor igniter port retention ring, the method including:
installing a combustor igniter port assembly, the combustor igniter port assembly including
a combustor tower positionable to projecting radially outward from a combustor outer wall, the combustor tower positionable on the combustor outer wall to encircle an aperture included in the combustor wall, the combustor tower including a keeper on an inner wall of the combustor tower and a horizontal flange, the horizontal flange axially spaced from the keeper, and
a ferrule disposed radially outward from at least a portion of the combustor tower, the ferrule including a flange,
compressing the combustor igniter port retention ring to a diameter smaller than a diameter of an inner wall of the combustor tower;
inserting the compressed combustor igniter port retention ring in to the keeper of the combustor tower where the flange of the ferrule is disposed radially outward of at least a portion of the combustor tower and radially inward of the retention ring;
releasing the compressed combustor igniter port retention ring; and
expanding the combustor igniter port retention ring to fit into the keeper of the combustor tower, the flange of the ferrule disposed between the horizontal flange and the combustor igniter port retention ring, a gap disposed between the combustor igniter port retention ring and the flange of the ferrule to allow axial movement of the ferrule.

9. The method of claim 8 wherein the keeper is a recessed groove in a wall of the combustor tower.

10. The method of claim 8 wherein the combustor tower includes a vertical wall, the horizontal flange radially outward from the vertical wall, and a vertical flange radially outward from the horizontal flange.

11. The method of claim 8 further comprising compressing the combustor igniter port retention ring and removing the combustor igniter port retention ring from the combustor tower.

12. The method of claim 8, wherein the combustor igniter port retention ring is a snap ring.

13. The method of claim 8, wherein the combustor igniter port retention ring is a spiral lock type ring.

14. The method of claim 8, wherein the combustor igniter port retention ring is horseshoe shaped.

15. A combustor igniter port assembly comprising:
a combustor tower projecting radially outward from a combustor outer wall of a combustor section of a gas turbine engine, the combustor outer wall forming a radially outer surface of the combustor section and the combustor tower positioned on the combustor outer wall to encircle an aperture included in the combustor wall, the combustor tower including a keeper on an inner wall of the combustor tower and a horizontal flange, the horizontal flange axially spaced from the keeper;
a ferrule disposed radially outward from at least a portion of the combustor tower, the ferrule including a flange; and
a retention ring disposed within the keeper of the combustor tower, the flange of the ferrule disposed radially outward of at least a portion of the combustor tower and radially inward of the retention ring, the flange of the ferrule disposed between the horizontal flange and the retention ring, a gap disposed between at least one of the retention ring and the flange of the ferrule or the flange of the ferrule and the horizontal flange to allow axial movement of the ferrule,
wherein the retention ring has elasticity to vary a diameter of the retention ring.

16. The assembly of claim 15, wherein the ferrule comprises a wear coating.

17. The assembly of claim 15, wherein a pressure outside of the combustor section radially outward of the combustor outer wall is greater than a pressure inside of the combustor section radially inward of the combustor outer wall.

18. The assembly of claim 15, wherein the combustor section is disposed within a gas turbine engine.

19. The assembly of claim 15, wherein the retention ring is a snap ring.

20. The assembly of claim 15, wherein the retention ring is a spiral lock ring.
